(19) United States
(12) Patent Application Publication
(10) Pub. No.: US 2014/0095398 A1
(43) Pub. Date: Apr. 3, 2014

(54) Double ID Anti-Counterfeit Method and System

(71) Applicant: Robert Y. Lin, Cupertino, CA (US)

(72) Inventor: Robert Y. Lin, Cupertino, CA (US)

(21) Appl. No.: 13/633,873

(22) Filed: Oct. 2, 2012

(51) Int. Cl. G06Q 30/00

(52) U.S. Cl. CPC G06Q 30/0185
USPC 705/318

(57) ABSTRACT

An anti-counterfeit method and system using the identity codes and marks of both products and merchants for authenticating goods are disclosed, where a client apparatus acquires identity codes via their marks of both a merchant and its plurality of products and sends codes to an authentication server. The server compares the codes in the client request with the codes in its database. The match result together with the detail merchant description and status is sent back to the client apparatus as the indication of authenticity of the products and the merchant at the point of sale.

### US PATENT REFERENCE

| | | |
|---|---|---|
| 8,249,350 | Aug. 21, 2012 | Voloshynovskyy, et al. |
| 8,248,254 | Aug. 21, 2012 | Vogt, et al. |
| 8,141,908 | Mar. 27, 2012 | Whiteman, et al.. |
| 8,126,203 | Feb. 28, 2012 | Rhoads, el al. |
| 8,111,431 | Feb. 07, 2012 | Silverbrook, et al. |
| 8,077,905 | Dec. 13, 2011 | Rhoads, et al. |
| 8,022,832 | Sep. 20, 2011 | Vogt, et al. |
| 8,001,013 | Aug. 16, 2011 | Serbanescu |
| 8,000,496 | Aug. 16, 2011 | Keswani, et al |
| 7,996,319 | Aug. 09, 2011 | Dillon |
| 7,992,772 | Aug. 09, 2011 | Grant, et al. |
| 7,983,451 | Jul. 19, 2011 | Super, et al |
| 7,980,467 | Jul. 19, 2011 | Silverbrook, et al |
| 7,938,331 | May 10, 2011 | Brock, et al. |
| 7,917,443 | Mar. 29, 2011 | Dillon |
| 7,774,268 | Aug. 10, 2010 | Bradley |
| 7,770,783 | Aug. 10, 2010 | Grant, et al |
| 7,752,137 | Jul. 06, 2010 | Dillion |
| 7,614,546 | Nov. 10, 2009 | Grant, et al |
| 7,602,291 | Oct. 13, 2009 | Tseng, et al |
| 7,571,856 | Aug. 11, 2009 | Lo |
| 6,882,737 | Apr. 19, 2005 | Lofgren, et al |
| 6,608,911 | Aug. 19, 2003 | Lofgren, et al |

### FIELD OF THE INVENTION

The present invention relates to anti-counterfeiting measures, and in particular, to a method of authentication of goods to prevent counterfeit or piracy.

### FOREIGN APPLICATION PRIORITY DATA

| | | |
|---|---|---|
| Oct. 20, 2011 | 201110319943.7 | China Patent Office |

### BACKGROUND OF THE INVENTION

Protection of valuable products, goods and brand names are crucial to the success of modern free market. In the world of globalization, counterfeiting is an increasingly significant problem. Counterfeiting not only can greatly impact business entities to cause them to lose profit or even to go out of business; but also affect consumers who unknowingly purchase these inferior counterfeiting goods with potential dire consequences.

To prevent counterfeiting, many techniques have been developed over the time. However, most of today's anti-counterfeiting technologies are centered on using unique identity mark to associate with the goods to be protected, where various means are used to make such unique identity mark difficult to duplicate. There are two fundamental types of anti-counterfeiting identity mark commonly seen in practical applications. One type is printing based product identity mark, such as using holograms, light sensitive ink, scratch off label, and etc. However, this approach is often ineffective because these mark, no matter how complex, can be quickly copied by counterfeiters using the same technologies and even the same equipments. Another type is RF chip based mark, such as RFID, where a product identity code can be embedded inside the chip and later verified and authenticated via a special scanner. The RF chip based identity mark is harder to duplicate. However, add a RF chip to each product can significantly increase the overall cost of goods. Moreover, the need of special devices to read RF chip identity mark that are rarely available to common consumers further restrict its broad usage in practice to few but very special cases.

Recently with the advance of mobile internet, proposals of using encrypted and coded mark whose hidden identity are acquired by a portable device and sent it to remote server for authentication are available. However, these proposed approaches can still be tampered and become ineffective since the encrypted and coded mark for the genuine goods itself can still subject to counterfeiting to any desired quantity to result the server authenticate a duplicated “genuine mark” on the counterfeiting goods.

Hence it is desirable to invent a more reliable but yet simple and cost-effective anti-counterfeiting method and system. This is the subject of the present invention.

### SUMMARY OF THE INVENTION

The present invention discloses a method and system for the authentication of genuine goods to prevent counterfeits. In one embodiment of invention, the system for anti-counterfeiting includes a client apparatus, an authentication server, a product identity mark, a merchant identity mark, and a communication channel between said client and said server. Both product identity mark and merchant identity mark are embedded with their corresponding unique identity codes. These codes are entered and stored in a database of the authentication server before goods entering into commerce. The client apparatus includes software to scan the merchant identity mark and product identity mark to acquire both identity codes to send them to authentication server. The server will compare the product and merchant identity code pairs with the previous code pairs stored information in database for a match. The match result together with detail information of the merchant is sent to the client apparatus as indication for genuineness of the goods and for detecting the counterfeits.

A major advantage of the invention is that it is very tamper resistant. Another advantage is that it is very simple and cost effective to implement the embodiment of the present invention.

### BRIEF DESCRIPTION OF THE DRAWINGS

FIG. 1 illustrates schematically one embodiment of the proposed double identity authentication method and its basic information flow.

FIG. 2 illustrates one embodiment of product identity code and mark composition.

FIG. 3 illustrates one embodiment of merchant identity code and mark composition.

FIGS. 4 is a block diagram illustrating the sequence of authentication operation steps of the client apparatus and the authentication server for one embodiment of the invention.

### DETAILED DESCRIPTION OF THE INVENTION

The present invention proposes a novel authentication method and system for most of goods. Unlike most of existing methods, the authentication here uses both a product identity mark and a merchant identity mark to accomplish the verification of goods' authenticity.

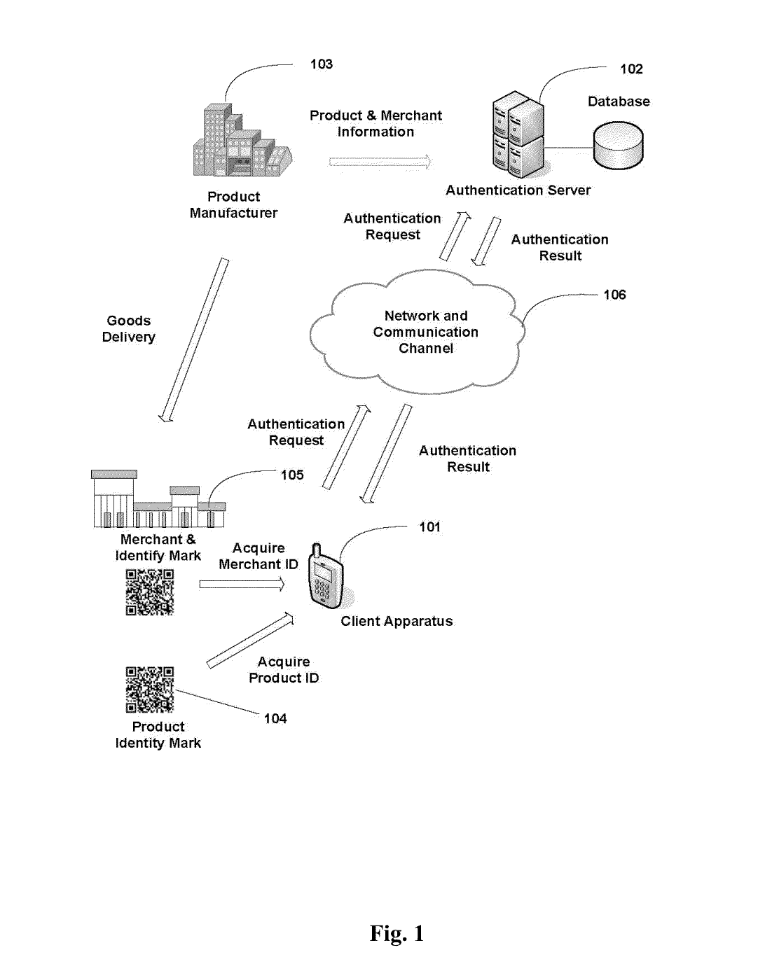

FIG. 1 illustrates schematically one exemplar system of the embodiment of proposed invention that include a client apparatus 101, an authentication server with database 102, a manufacturer 103, a product identity mark 104, a merchant identity mark 105 and communication channel between said client and said server 106. An embodiment of the invention uses both product identity mark and merchant identity mark for the authentication verification of a product. Consistent with an embodiment of the present invention, the client apparatus 101 can be a portable device with camera running software program, such as a smart phone or a tablet that are commonly available to consumers; while the authentication server 106 may be operated by a service provider offering anti-counterfeiting verification to all manufacturers.

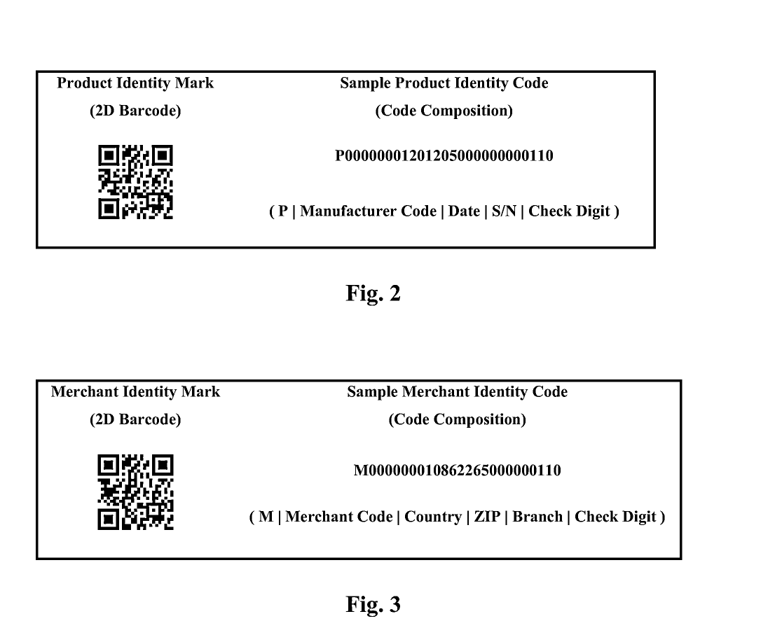

A product identity mark 104 contains a universally unique identity code that is only associated with just one single product. This is true among the same type of products from the same manufacturer as well as among the different types of products from the different manufacturers. The invention itself does not limit the usage of any technologies and methods for the generation of either product or merchant identity marks as long as the embedded unique identity code in the mark can be easily acquired through the client apparatus, such as smart phone or a tablet computer. These marks can be as simple as a 2D barcode on a printing label firmly attached to product goods and a 2D barcode printed on posters on various locations of a merchant. The choice of mark type will not affect the authentication result of the proposed invention. FIG. 2 illustrates one implementation example of the product identity code and mark using common 2D barcode. This design is intended as an example for the description of the embodiment of the present invention and not as a restriction. Similarly, each merchant identity mark 105 is also generated uniquely among all merchants. FIG. 3 illustrates one merchant identity code design for the embodiment of invention together with its identity mark represented by a 2D barcode. Both product identity code and merchant identity code may be transferred to their corresponding product identity mark and merchant identity mark through printing and engraving technologies and methods. The identity code and identity mark represent the same identity information in the different form. In this description, they are sometimes used interchangeably. In one embodiment of invention, the product identity code is part of said detail product information and can be utilized as a key to retrieve other product information and its associated destined merchant information from the relation database of the authentication server.

As shown in FIG. 1, before product goods are delivered from their manufacturers 103 to enter into commerce and to reach the point of sale 105, their detail product information including detail description, pictures, specification, packaging type, suggested pricing, expiration date, and most importantly its identity code of each product, together with their destined merchant of the point of sale 105 is entered into a database of the authentication server. The product identity codes are generated and assigned by the authentication service provider who uses an embodiment of invention when a manufacturer signs on to use the service.

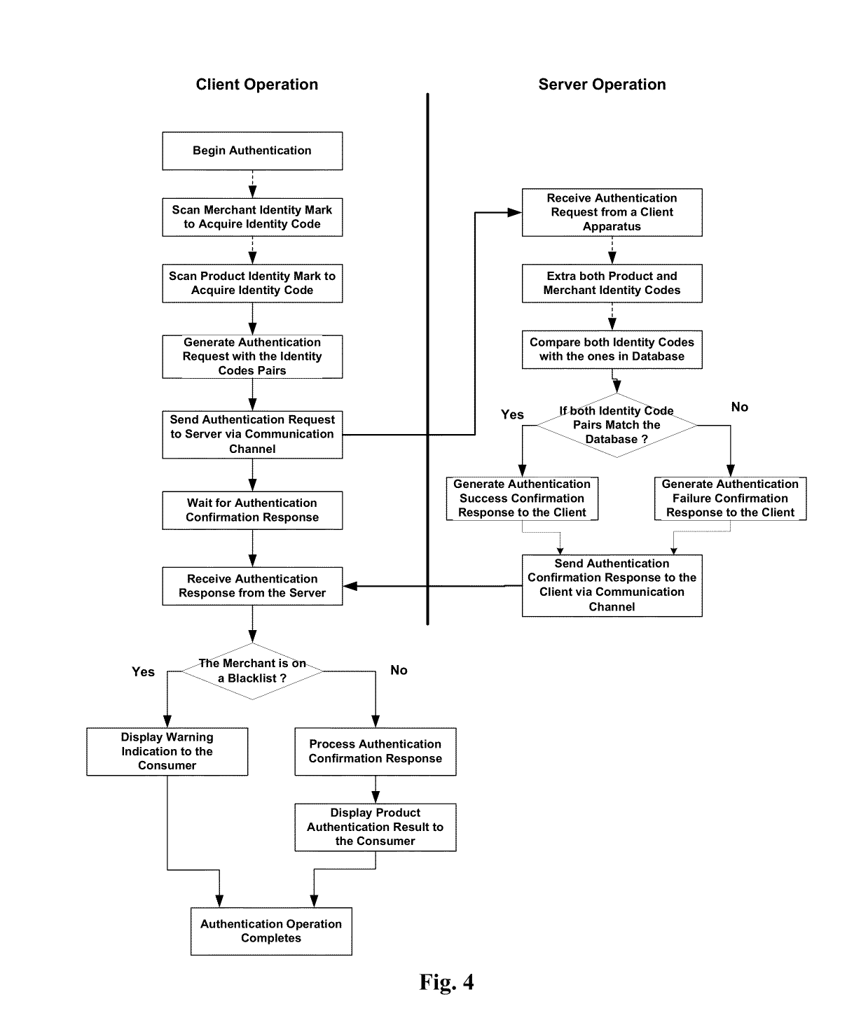

A product authentication occurs after the goods enter into commerce at the point of sale 105. For example, in a shopping store, a consumer wants to verify the goods' genuineness before making the purchase. During the product authentication operation, which is illustrated in FIG. 4's flow chart, a consumer will utilize a client apparatus 101, such as smart phone or tablet computer, to scan the merchant identity mark that are posted inside the store to acquire the unique identity code embedded in the mark for the associated merchant; and to scan the product identity mark attaching into the goods to acquire its embedded product identity code. The client apparatus will use both merchant and product identity codes to generate a product authentication verification request message to the authentication server 102 through the communication channel 106. After receiving the authentication request, the server 102 will extract both merchant and product identity codes from the message to match them with the same codes priorly stored in its database. If both product and merchant identity codes from the request message match those in the server's database, it then concludes that the authentication of the goods is confirmed as genuine and the server 102 will respond to the client with a confirmation message indicating the success of authentication for the genuine goods to the consumer via the same communication channel 106. Specifically in the confirmation indication, it will explicitly emphasize to the consumer that this particular genuine goods is sold only at one particular merchant with the detail merchant information explicitly presented. If the goods is sold anywhere else other than at this one particular merchant site, it is regarded as counterfeit according to an embodiment of the present invention. This principle is the core of the embodiment of the invention to secure the reliability and accuracy of the authentication and to prevent authentication tampering and counterfeiting. However, if either identity code from the said authentication request message does not match the corresponding one in the server database, it is then concludes that the goods is a counterfeit. Furthermore, if a merchant has been found to be a repeating counterfeit violator, it can be added to a blacklist and marked as such in the server database. The authentication response confirmation message can include this blacklist status as additional warning indication to the consumer to help protect him from other counterfeits in the store that are not part of this embodiment of the invention.

The main advantage of the embodiment of the invention is that the proposed authentication method and system is resistant to tampering and duplication of product and merchant identity marks in the case of counterfeiting. Here assuming that the product identity mark of a genuine goods is duplicated by a counterfeiter and put onto a counterfeit goods; and further assume that the merchant identity mark of the legit merchant where the genuine goods is destined for sell is also duplicated and is posted in a counterfeit store in order to circumvent the authentication for the embodiment of the invention. When this scenario occurs, the said authentication procedure of one embodiment of the invention will cause the server 102 to respond back to client apparatus 101 with the same successful authentication result for the counterfeit, except for one important fact that the successful authentication result to a consumer at client apparatus contains one crucial detail description of the genuine merchant, including its location, web address, photos and many other merchant associating features that will be totally different from this faked merchant of the counterfeiter's. This difference will immediately alert the consumer to the sense that this erroneous merchant is a counterfeiter, hence to cause the consumer to abandon the current sale transaction of the counterfeit goods.

Even though with the modern technologies and equipments, it is very easy to duplicate any anti-tampering labels and marks, the fact is that it is virtually impossible for a counterfeiter to duplicate a counterfeiting merchant, either at the same physical location; or online with the same web address as the genuine one without being quickly detected by public and being shut down by law enforcement authorities. This makes the embodiment of the invention unique and tamper-resistant. Because of this unique characteristics, there is no need to put heavy security load on the identity mark itself, such as using watermark, hologram, and etc . This will significantly reduce the cost of generating identity mark itself and make the embodiment of the invention widely applicable to protect all type of goods from the very low cost goods, such as organic farming products, to very expensive high end luxury goods.

Another advantage of the invention is that the same one embodiment of the invention can be used both in merchants with physical location, such as brick and mortar store, and in the virtual online stores.

In one embodiment of the invention, the optional encryption method can be utilized to scramble the data in the messages transmitted in the communication channel 106 between said client apparatus and said server to prevent eavesdropping and data tampering when passing through public internet.

The invention of a method and system for anti-counterfeits herein has been described in detail with reference to specific exemplary embodiments in order to provide a skilled in the art with the information needed to apply the novel principles in actual system. Although the present invention has been described in a singular number of identity mark and client apparatus, it will be clear that the embodiment of invention apply to plurality of product identity marks, merchant identity marks, client apparatus and even authentication servers. It will be also be clear that various modifications and adjustments may be made to these embodiments without departing from the broader principles and scope of the invention. Accordingly, the specification and drawings are to be regarded as illustrative rather than restrictive.

What is claimed is:

1. A method for product anti-counterfeit, comprising:
a. generating a product identity mark embedded with a universally unique code for each product and a merchant identity mark with a equally universally unique code for each merchant; and store both said product and merchant identity codes together with the associating detail product and merchant information into a database of a authentication server prior to the commitment of the product to the actual commerce.
b. scanning both merchant and product identity mark by using a client apparatus to acquire unique code pairs of goods and said merchant to send to the server through a communication channel for a comparison match of their counterpart code pairs of said goods and said merchant in said database; and wherein said server sends both the code pairs matching result and the detail description of the said merchant to said client apparatus in result messages as indication of authenticity of said goods and said merchant to the consumer to achieve anti-counterfeits.

2. The method of claim 1, wherein a product identity mark with a unique code is generated for each goods to be protected; wherein the code together with the detail description of the product itself, the manufacturer and the merchant of the point of sale in which the goods is intended to be in commerce, are entered into the database of the authentication server prior to the goods entering into commerce. The product identity mark is to be scanned at any time to acquire the corresponding identity code when the authenticity of the goods is to be verified by a consumer.

3. The method of claim 1, wherein a merchant of sale point for the goods is assigned a unique merchant identity mark with a unique code as part of the authentication method for said client apparatus to scan; and where this unique code together with the detail description of the said merchant, including its location, contact, web address, telephone, photos, reputation, business scope and other data associating with a merchant, are entered into the database of the authentication server prior to goods entering into retail circulation.

4. The method of claim 1, wherein each authentic goods represented by its globally unique identity code and mark has one to one association with one single merchant using said merchant identity code and mark at the point of sale.

5. The method of claim 1, wherein a merchant's detail information consists of description, location, contact, photo and web address are used to generate a merchant certification message to send to the said client apparatus to inform the consumer during the said authentication process.

6. The method of claim 1, wherein an unreliable merchant with history of counterfeiting goods and consumer complains are added into a blacklist and are marked in said authentication server database wherein during the authentication process, this marked status is utilized to generate a special indication on the client apparatus to inform the consumer of such a fact of such an unreliable merchant and inherently all its goods.

7. The method of claim 1, wherein said authentication matching and processing of product identity of goods and their merchant identity are performed on said server.

8. A system for product anti-counterfeit, comprising:
a. a product identity mark and merchant identity mark and their associating identity codes, a client apparatus, an authentication server, and a communication channel between the client apparatus and the server.
b. a unit for generating product identity mark embedded with a universally unique code for each product and merchant identity mark with a equally universally unique code for each merchant; and store both product and merchant identity codes together with the associating detail product and merchant information into database of said authentication server prior to the commitment of the product to the actual commerce.
c. a client apparatus scans both merchant and product identity mark to acquire unique code pairs of said goods and said merchant to send to the server through the communication channel to said authentication server.
d. said authentication server for receiving the pair of identity codes of said goods and the said merchant from a client apparatus to compare them with their counterpart code pairs in the database; and wherein said authentication server sends both the code pairs matching result and the detail description of the said merchant to the client apparatus in result messages as indication of authenticity of said goods and said merchant to the consumer to achieve anti-counterfeits.

9. The system of claim 8, wherein a product identity mark with a unique code is generated for each good to be protected; wherein the code together with the detail description of the product itself, the manufacturer and the merchant of the point of sale in which the good is intended to be in commerce, are entered into the database of the authentication server prior to the goods entering into commerce. The product identity mark is to be scanned at any time to acquire the corresponding code when the authenticity of the goods is to be verified by a consumer.

10. The system of claim 8, wherein a merchant of the point of sale for the goods is assigned a unique merchant identity mark with a unique code as part of the authentication system for said client apparatus to scan; and wherein this unique code together with the detail description of the said merchant, including its location, contact, web address, telephone, photos, reputation, business scope and other data associating with a merchant, are entered into said database of said authentication server prior to goods entering into retail circulation.

11. The system of claim 8, wherein each authentic goods represented by its globally unique identity code and mark has one to one association with one single merchant using said merchant identity code and mark at the point of sale.

12. The system of claim 8, wherein a merchant's detail information consists of description, location, contact and web address are used to generate a merchant certification message to send to the said client apparatus to inform the consumer during the said authentication process.

13. The system of claim 8, wherein an unreliable merchant with history of counterfeiting goods and consumer complains are added into a blacklist and are marked in said authentication server database where during the authentication process, this marked status is used to generate a special indication on the client apparatus to inform the consumer of such a fact of such an unreliable merchant and inherently all its goods.

14. The system of claim 8, wherein said authentication matching and processing of product identity of goods and their merchant identity are performed on said authentication server.
